(19) United States
(12) Patent Application Publication
(10) Pub. No.: US 2007/0238494 A1
(43) Pub. Date: Oct. 11, 2007

(54) Portable electronic device

(76) Inventor: Long-Jyh Pan, Shijr City (TW)

Correspondence Address: RABIN & Berdo, PC, 1101 14TH STREET, NW, SUITE 500, WASHINGTON, DC, 20005, US

(21) Appl. No.: 11/445,231

(22) Filed: Jun. 2, 2006

(30) Foreign Application Priority Data
Jun. 2, 2005 (TW) 94118257

(51) Int. Cl. H04M 1/02

(52) U.S. Cl. 455/575.4

(57) ABSTRACT

A portable electronic device including a first casing, a second casing and a carrier is provided. The first casing has a first surface having a guide slot and a slide slot. The guide slot has a first wide opening, a narrow opening and a second wide opening. The narrow opening is positioned between the first and the second wide openings. The second casing has a second surface. The carrier has an elastomer whose two ends are coupled to two opposite walls of the guide slot. When the elastomer is moved from the first or the second wide opening to the narrow opening, the elastomer is compressed to generate a compressed elastic force. When the elastomer partly passes the narrow opening, the elastomer releases the compressed elastic force and moves towards the first or the second wide opening so that the first casing slides with respect to the second casing.

This application claims the benefit of Taiwan application Serial No. 94118257, filed Jun. 2, 2005, the subject matter of which is incorporated herein by reference.

### BACKGROUND OF THE INVENTION

1. Field of the Invention

The invention relates in general to a portable electronic device, and more particularly to a portable electronic device with two relatively slideable casings.

2. Description of the Related Art

Living in today's society where science and technology advance rapidly, portable electronic devices have become indispensable to modern people in their everyday life. The mobile phone in particularity, with the features of slimness, light weight and portability, conveniently enables people to be connected whenever and wherever desired. Take the slide-type mobile phone for example, a slide module is disposed between the first casing and the second casing, so that the first casing can slide with respect to the second casing.

However, with-the slide module being disposed between the first casing and the second casing, the overall thickness of the slide-type mobile phone will be increased. This is contradictory to the current trend of the design of mobile phone which pursuing slimness, compactness and lightweight. Besides, the assembly of the complicated parts of slide module is time consuming and further increases manufacturing cost.

### SUMMARY OF THE INVENTION

It is therefore an object of the invention to provide a portable electronic device. The design of correspondingly disposing an elastomer, a carrier, a guide slot, a slide slot and a slide track in the first casing and the second casing not only enables the first casing and the second casing to slide with respect to each other, but also reduces the thickness of the portable electronic device, simplifies the assembly of components and reduces manufacturing cost.

The invention achieves the above-identified object by providing a portable electronic device including a first casing, a second casing and a carrier. The first casing has a first surface. The first surface has a guide slot and a slide slot. The guide slot has a first wide opening, a narrow opening and a second wide opening. The narrow opening is positioned between the first wide opening and the second wide opening. The second casing has a second surface facing the first surface. The second surface has a slide track. The carrier is disposed inside the first casing and is connected to the slide track via the slide slot. The carrier has an elastomer whose two ends are coupled to two opposite walls of the guide slot. When the elastomer is moved from the first wide opening or the second wide opening to the narrow opening, the elastomer is compressed to generate a compressed elastic force. When the elastomer partly passes the narrow opening, the elastomer releases the compressed elastic force and moves towards the second wide opening or the first wide opening, so that the first casing slides with respect to the second casing.

The invention achieves the above-identified object by providing another portable electronic device including a first casing, a keypad, a second casing and a carrier. The first casing has a first surface. The first surface has a guide slot and a slide slot. The guide slot has a first wide opening, a narrow opening and a second wide opening. The narrow opening is positioned between the first wide opening and the second wide opening. The slide slot is positioned at one side of the guide slot. The keypad is disposed on the first surface. The second casing has a second surface facing the first surface. The second surface has a slide track. The carrier is disposed inside the first casing and connected to the slide track via the slide slot. The carrier has an elastomer whose two ends are coupled to two opposite walls of the guide slot. When the elastomer is moved from the first wide opening or the second wide opening to the narrow opening, the elastomer is compressed to generate a compressed elastic force. When the elastomer partly passes the narrow opening, the elastomer release the compressed elastic force and moves towards the second wide opening or the first wide opening, so that the first casing slides with respect to the second casing. When the elastomer is at the first wide opening, the keypad is completely covered by the second casing. When the elastomer is at the second wide opening, the keypad is exposed outside the second casing.

The invention achieves the above-identified object by providing yet another portable electronic device including a first casing, a second casing, a keypad and a carrier. The first casing has a first surface. The first surface has a guide slot and a slide slot. The guide slot has a first wide opening, a narrow opening and a second wide opening. The narrow opening is positioned between the first wide opening and the second wide opening. The slide slot is positioned at one side of the guide slot. The second casing has a second surface facing the first surface. The second surface has a slide track. The keypad is disposed on the second surface. The carrier is disposed inside the first casing and connected to the slide track via the slide slot. The carrier has an elastomer whose two ends are coupled to two opposite walls of the guide slot. When the elastomer is moved from the first wide opening or the second wide opening to the narrow opening, the elastomer is compressed to generate a compressed elastic force. When the elastomer partly passes the narrow opening, the elastomer releases the compressed elastic force and moves towards the second wide opening or the first wide opening, so that the first casing slides with respect to the second casing. When the elastomer is at the first wide opening, the keypad is completely covered by the first casing. When the elastomer is at the second wide opening, the keypad is exposed outside the first casing.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an exploded diagram of a portable electronic device according to a preferred embodiment of the invention;

FIG. 2 is an enlarged diagram of a first element of a first casing, a second surface of a second casing and a carrier in FIG. 1 viewed from upside-down;

FIG. 3 is an enlarged assembly diagram of a first element of a first casing, a second surface of a second casing, and a carrier and flexible circuit board in FIG. 1 viewed from upside-down;

FIG. 4 is an enlarged assembly diagram showing an elastomer of a carrier in. FIG. 1 is coupled to a first wide opening of a guide slot of a first casing;

FIG. 5 is an enlarged assembly diagram showing a portable electronic device according to a preferred embodiment of the invention is at a close mode;

FIG. 6 is an assembly diagram showing an elastomer in FIG. 4 is coupled to a second wide opening of a guide slot;

FIG. 7 is a diagram showing the state of a first element of a first casing, a second surface of a second casing, a carrier and a flexible circuit board in FIG. 3 when an elastomer is coupled to a second wide opening of a guide slot;

FIG. 8 is an enlarged assembly diagram showing the state when a portable electronic device according to a preferred embodiment of the invention is at an open mode; and

FIG. 9 is an assembly diagram showing the state when an elastomer in FIG. 4 is coupled to a narrow opening of a guide slot.

### DETAILED DESCRIPTION OF THE INVENTION

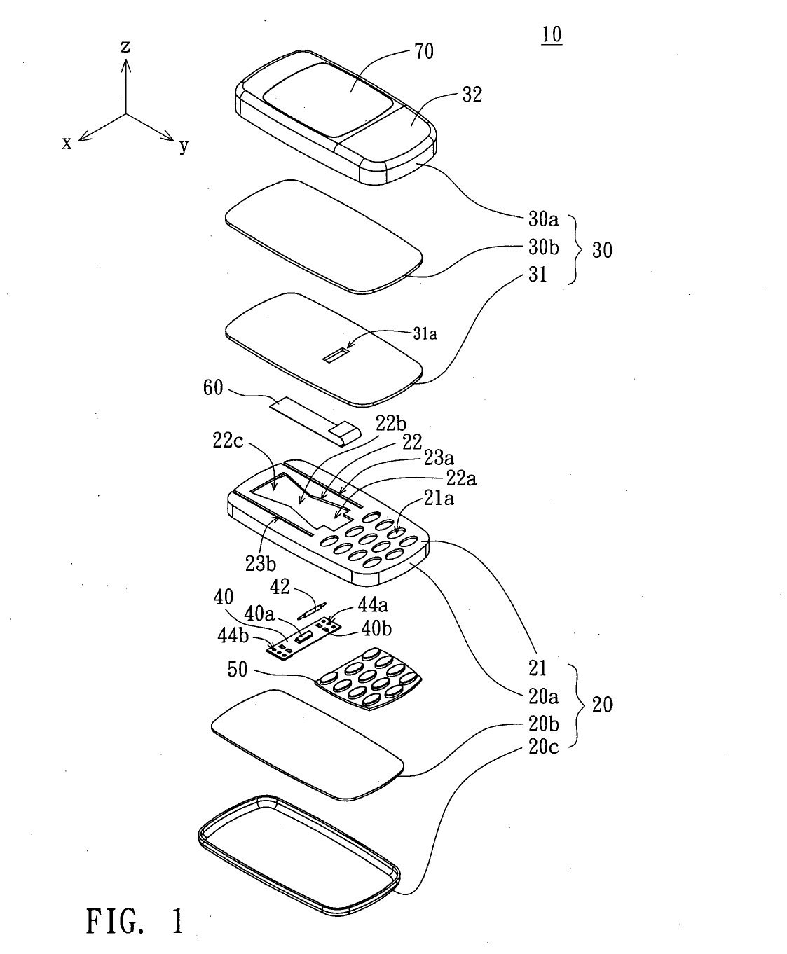

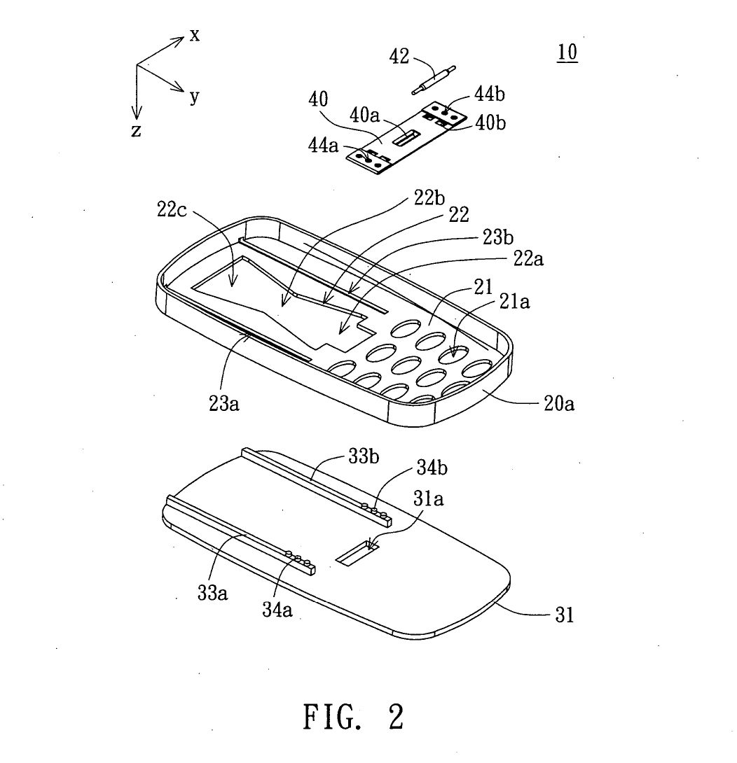

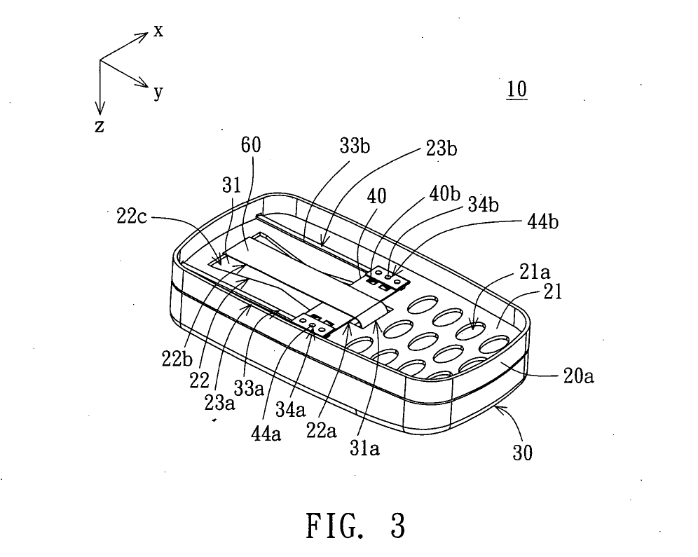

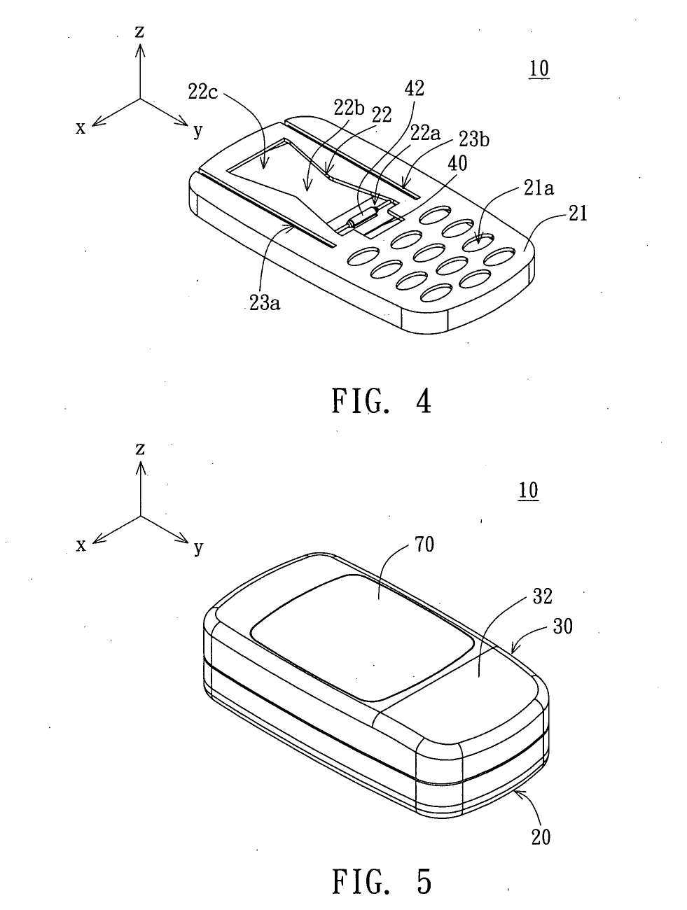

Referring to FIGS. 1-5 at the same time. FIG. 1 is an exploded diagram of a portable electronic device according to a preferred embodiment of the invention. FIG. 2 is an enlarged diagram of a first element of a first casing, a second surface of a second casing and a carrier in FIG. 1 viewed from upside-down. FIG. 3 is an enlarged assembly diagram of a first element of a first casing, a second surface of a second casing, and a carrier and flexible circuit board in FIG. 1 viewed from upside-down. FIG. 4 is an enlarged assembly diagram showing an elastomer of a carrier in FIG. 1 is coupled to a first wide opening of a guide slot of a first casing. FIG. 5 an enlarged assembly diagram showing a portable electronic device according to a preferred embodiment of the invention is at a close mode. As shown in FIG. 1, the portable electronic device 10 includes a first casing 20, a second casing 30 and a carrier 40. The first casing 20 has a first surface 21 having a guide slot 22 and a first slide slot 23a disposed thereon. As shown in FIGS. 1˜4, the guide slot 22 has a first wide opening 22a, a narrow opening 22b and a second wide opening 22c. The narrow opening 22b positioned between the first wide opening 22a and the second wide opening 22c connects the first wide opening 22a and the second wide opening 22c. The first slide slot 23a is positioned at one side of the guide slot 22.

As shown in FIGS. 1˜3, the second casing 30 has a second surface 31 facing the first surface 21, and the second surface 31 has a first slide track 33a. The first slide track 33a can slide within the first slide slot 23a, so that the first casing 20 can slide with respect to the second casing 30 along an extended direction of the first slide track 33a and the first slide slot 23a.

As shown in FIGS. 1˜4, the carrier 40 is disposed inside the first casing 20 and connected to the first slide track 33a via the first slide slot 23a, so that the carrier 40 can synchronize with the movement of the second casing 30 to move within the first casing 20. The first casing 20 and the second casing 30 are assembled together via incorporation of the carrier 40, the first slide slot 23a and the first slide track 33a. The carrier 40 has an elastomer 42 whose two ends are coupled to two opposite walls of the guide slot 22. In present embodiment, the two ends of the elastomer are correspondingly abutted against the two opposite walls of the guide slot 22.

As shown in FIGS. 3˜4, when the elastomer 42 is at the first wide opening 22a, the first casing 20 and the second casing 30 are at a close mode, and the first surface 21 is completely covered by the second casing 30 as shown in FIG. 5.

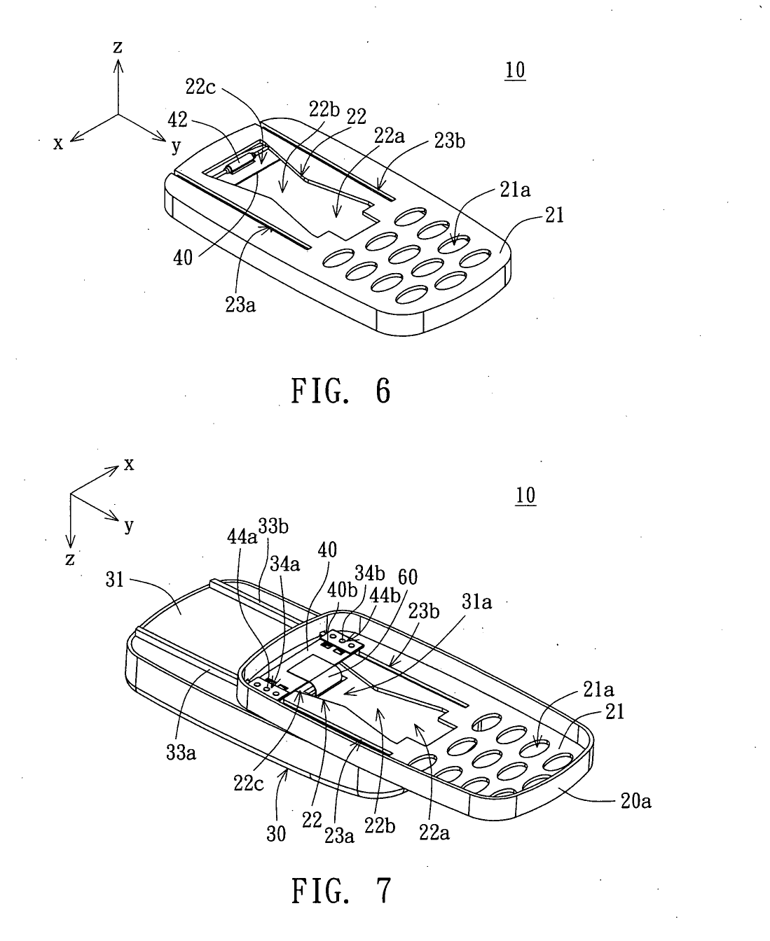

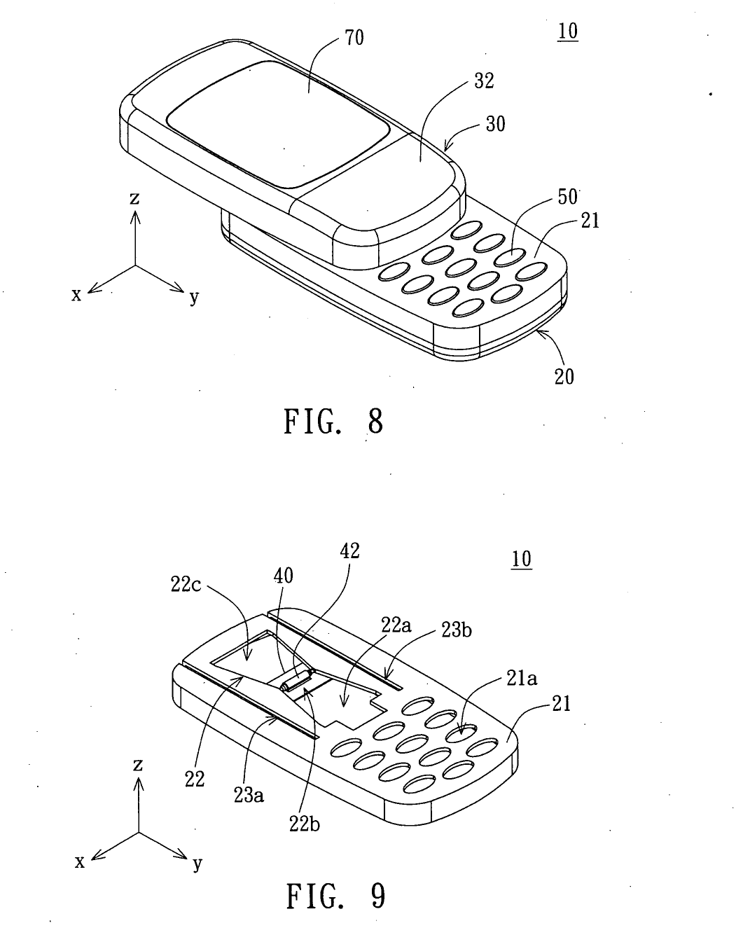

Referring to FIGS. 6˜8 at the same time. FIG. 6 is an assembly diagram showing an elastomer in FIG. 4 is coupled to a second wide opening of a guide slot. FIG. 7 is a diagram showing the state of a first element of a first casing, a second surface of a second casing, a carrier and a flexible circuit board in FIG. 3 when an elastomer is coupled to a second wide opening of a guide slot. FIG. 8 is an enlarged assembly diagram showing the date when a portable electronic device according to a preferred embodiment of the invention at an open mode. As shown in FIGS. 6˜7, when the elastomer 42 is at the second wide opening 22c, the first casing 20 and the second casing 30 are at an open mode, so that part of the first surface 21 is exposed outside the second casing 30 as shown in FIG. 8.

When the user would like to switch the portable electronic device 10 to the open mode from the close mode, the user can apply a force to the first casing 20 or the second casing 30, so that the first casing 20 slides with respect to the second casing 30. Referring to FIG. 9, an assembly diagram showing the state when an elastomer in FIG. 4 is coupled to a narrow opening of a guide slot is shown. As shown in FIG. 9, when the elastomer 42 in FIG. 4 is moved from the first wide opening 22a to the narrow opening 22b, the elastomer 22 is compressed to generate a compressed elastic force. When the user slides the first casing 20 with respect to the second casing 30 to an appropriate distance and when the elastomer 42 in FIG. 9 partly passes the narrow opening 22b, the user can remove the applied force. Meanwhile, the elastomer 42 releases the compressed elastic force and moves towards the second wide opening 22c, so that the first casing 20 slides with respect to the second casing 30 until the elastomer 42 reaches the second wide opening 22c. Meanwhile, the first casing 20 and the second casing 30 are at the open mode as shown in FIGS. 6˜8.

When the user would like to switch the portable electronic device 10 to the close mode from the open mode, the user can apply a force to the first casing 20 or the second casing 30, so that the first casing 20 slides with respect to the second casing 30. As shown in FIG. 9, when the elastomer 42 in FIG. 4 is moved from the second wide opening 22c to the narrow opening 22b, the elastomer 22 is compressed to generate the compressed elastic force. When the user slides the first casing 20 with respect to the second casing 30 to an appropriate distance, and when the elastomer 42 in FIG. 9 partly passes the narrow opening 22b, the user can remove the applied force. Meanwhile, the elastomer 42 releases the compressed elastic force and moves towards the first wide opening 22a, so that the first casing 20 slides with respect to the second casing 30 until the elastomer 42 reaches the first wide opening 22a. The first casing 20 and the second casing 30 are at the close mode as shown in FIGS. 3˜5.

In the present embodiment, the first casing 20 further includes a second slide slot 23b positioned at the another side of the guide slot 22. The second casing 30 further includes a second slide track 33b, a first side of the carrier 40 is connected to the first slide track 33a via the first slide slot 23a, and a second side of the carrier 40 is connected to the second slide track 33b via the second slide slot 23b. The first slide track 33a, the second slide track 33b, the first slide slot 23a and the second slide slot 23b are substantially parallel to each other. Besides, the first slide track 33a can be inserted into the first slide slot 23a with part of the structure being projected from inside the first casing 10, the first side of carrier 40 is connected to the part of the first slide track 33a projected from inside the first casing 10. Besides, the second slide track 33b can be inserted into the second slide slot 23b with part of the structure being projected from inside the first casing 10, and the second side of carrier 40 is connected to the part of the second slide track 33b projected from inside the first casing 10.

Besides, the first casing 20 includes a first element 20a, a second element 20c, a first circuit board 20b and a keypad 50. The first element 20a has a first surface 21 having a keypad opening 21a. The first element 20a is connected to the second element 20c and retains the first circuit board 20b and the keypad 50 with the second element 20c, so that the circuit board 20b is positioned inside the first casing 20. Part of the structure of the keypad 50 is projected from the first surface 21 via the keypad opening 21a to be electrically connected to the first circuit board 20b. When the elastomer 42 is at the first wide opening 22a, the keypad 50 is completely covered by the second casing 30. When the elastomer 42 is at the second wide opening 22b, the keypad 50 is exposed outside the second casing 30 to be availed by the user.

Besides, the second casing 30 includes a third element 30a, a second circuit board 30b and a display unit 70. The third element 30a is connected to the second surface 31 and retains the second circuit board 30b with the second surface 31, so that the second circuit board 30b is positioned inside the second casing 30. The display unit 70 is disposed on a third surface 32 opposite to the second surface 31 to be electrically connected to the second circuit board 30b.

Moreover, as shown in FIGS. 1˜3, the second surface 31 further has a hole 31a, and the portable electronic device 10 further includes a flexible circuit board 60. The flexible circuit board 60 passes the hole 31a and the guide slot 22 to electrically connect the first circuit board 20b and the second circuit board 30b. Besides, the carrier 40 further has a fixing component 40a, a number of anti-friction piece 40b, a number of first holes 44a, and a number of second holes 44b. The fixing component 40a fixes the elastomer 42 on the carrier 40. The anti-friction piece 40b supports the carrier 40 on the second surface 31 and reduces the friction between the carrier 40 and the second surface 31.

The portable electronic device 10 further includes a number of first plastic pillars 34a and a number of second plastic pillars 34b. The first plastic pillar 34a and the second plastic pillar 34b are respectively disposed on the first slide track 33a and the second slide track 33b for respectively passing through the first hole 44a and the second hole 44b. The first plastic pillar 34a correspondingly connect the first side of the carrier 40 and the first slide track 33a by means of hot melting, and the second plastic pillar 34b correspondingly connect the second side of the carrier 40 and the second slide track 33b by means of hot melting, so that the carrier 40 and the second casing 30 can be moved synchronically.

Anyone who is skilled in the technology of the present embodiment of the invention would understand that the technology of the present embodiment of the invention is not limited thereto. For example, the keypad can be disposed on the second surface 31. When the elastomer 42 is at the first wide opening 22a, the keypad disposed on the second surface 31 is completely covered by the first casing 20. When the elastomer 42 is at the second wide opening 22b, the keypad disposed on the second surface 31 is exposed outside the first casing 20. Besides, one end of the elastomer 42 can be compressed at the narrow opening 22b. The two ends of the elastomer 42 can be compressed at the narrow opening 22b. Furthermore, the guide slot 22 can be a sandglass-type opening. Each of the two walls of the guide slot 22 has a protrusion, and a narrow opening 22 is formed between the two protrusions. One wall of the guide slot 22 has a protrusion, and a narrow opening 22 is formed between the protrusion and another wall of the guide slot 22. The display unit 70 can be a liquid crystal display panel (LCD panel), an organic light emitting diode (OLED) display panel, a plasma display panel or an organic electroluminescent device (OELD). The portable electronic device 10 can be a mobile phone, a personal digital assistant (PDA) or a calculator.

According to the portable electronic device disclosed in above embodiment of the invention, an elastomer, a carrier, a guide slot, a slide slot and a slide track are correspondingly disposed in the first casing and the second casing, not only enabling the first casing and the second casing to slide with respect to each other, but also reducing the thickness of the portable electronic device, simplifying the assembly of components and reducing manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable electronic device, comprising:
a first casing having a first surface, wherein the first surface has a guide slot and a first slide slot, the guide slot has a first wide opening, a narrow opening and a second wide opening, the narrow opening is positioned between the first wide opening and the second wide opening, and the first slide slot is positioned at one side of the guide slot;
a second casing having a second surface, wherein the second surface faces the first surface and has a first slide track; and
a carrier disposed inside the first casing and connected to the first slide track via the first slide slot, wherein the carrier has an elastomer whose two ends are coupled to the two opposite walls of the guide slot;
wherein when the elastomer is moved from the first wide opening or the second wide opening to the narrow opening, the elastomer is compressed to generate a compressed elastic force;
wherein when the elastomer partly passes the narrow opening, the elastomer releases the compressed elastic force and moves towards the second wide opening or the first wide opening, so that the first casing slides with respect to the second casing.

2. The portable electronic device according to claim 1, wherein the first casing further comprises a second slide slot, the second slide slot is positioned at another side of the guide slot, wherein the second casing further comprises a second slide track, a first side of the carrier is connected to the first slide track via the first slide slot, and a second side of the carrier is connected to the second slide track via the second slide slot.

3. The portable electronic device according to claim 1, wherein when the elastomer is at the first wide opening, the first casing and the second casing are at a close mode, the first surface is completely covered by the second casing; and
wherein when the elastomer is at the second wide opening, the first casing and the second casing are at an open mode, so that part of the first surface is exposed outside the second casing.

4. The portable electronic device according to claim 3, further comprising:
a keypad disposed on the first surface, wherein the keypad is exposed outside the second casing when the first casing and the second casing are at the open mode.

5. The portable electronic device according to claim 1, wherein a first circuit board is disposed inside the first casing, a second circuit board is disposed inside the second casing, the second surface has a hole, the portable electronic device further comprises:
a flexible circuit board passing the hole and the guide slot to electrically connect the first circuit board and the second circuit board.

6. The portable electronic device according to claim 1, wherein when the elastomer is at the first wide opening, the first casing and the second casing are at a close mode, the second surface is completely covered by the first casing; and
wherein when the elastomer is at the second wide opening, the first casing and the second casing are at an open mode, so that part of the second surface is exposed outside the first casing.

7. The portable electronic device according to claim 6, further comprising:
a keypad disposed on the second surface, wherein the keypad is exposed outside the first casing when the first casing and the second casing are at the open mode.

8. The portable electronic device according to claim 1, wherein when the first casing slides with respect to the second casing, the first slide track slides within the first slide slot.

9. The portable electronic device according to claim 1, wherein the two ends of the elastomer are compressed at the narrow opening.

10. The portable electronic device according to claim 1, wherein one of the two ends of the elastomer is compressed at the narrow opening.

11. The portable electronic device according to claim 1, wherein the carrier has a plurality of hole, the portable electronic device further comprises:
a plurality of plastic pillar disposed on the first slide track for passing through the holes to connect the carrier and the first slide track by means of hot melting.

12. A portable electronic device, comprising:
a first casing having a first surface, wherein the first surface has a guide slot and a first slide slot, the guide slot has a first wide opening, a narrow opening and a second wide opening, the narrow opening is positioned between the first wide opening and the second wide opening, and the first slide slot is positioned at one side of the guide slot;
a keypad disposed on the first surface;
a second casing having a second surface, wherein the second surface faces the first surface and has a first slide track; and
a carrier disposed inside the first casing and connected to the first slide track via the first slide slot, wherein the carrier has an elastomer whose two ends are coupled to the two opposite walls of the guide slot;
wherein when the elastomer is moved from the first wide opening or the second wide opening to the narrow opening, the elastomer is compressed to generate a compressed elastic force;
wherein when the elastomer partly passes the narrow opening, the elastomer releases the compressed elastic force and moves towards the second wide opening or the first wide opening, so that the first casing slides with respect to the second casing;
wherein when the elastomer is at the first wide opening, the keypad is completely covered by the second casing;
wherein when the elastomer is at the second wide opening, the keypad is exposed outside the second casing.

13. The portable electronic device according to claim 12, wherein the first casing further comprises a second slide slot, the second slide slot is positioned at the another side of the guide slot, wherein the second casing further comprises a second slide track, a first side of the carrier is connected to the first slide track via the first slide slot, a second side of the carrier is connected to the second slide track via the second slide slot.

14. The portable electronic device according to claim 12, wherein a first circuit board is disposed inside the first casing, a second circuit board is disposed inside the second casing, the second surface has a hole, the portable electronic device further comprises:
a flexible circuit board passing through the hole and the guide slot to electrically connect the first circuit board and the second circuit board.

15. The portable electronic device according to claim 12, wherein when the first casing slides with respect to the second casing, the first slide track slides within the first slide slot.

16. A portable electronic device, comprising:
a first casing having a first surface, wherein the first surface has a guide slot and a first slide slot, the guide slot has a first wide opening, a narrow opening and a second wide opening, the narrow opening is positioned between the first wide opening and the second wide opening, and the first slide slot is positioned at one side of the guide slot;
a second casing having a second surface, wherein the second surface faces the first surface and has a first slide track;
a keypad disposed on the second surface; and
a carrier disposed inside the first casing and is connected to the first slide track via the first slide slot, wherein the carrier has an elastomer whose two ends are coupled to the two opposite walls of the guide slot;
wherein when the elastomer is moved from the first wide opening or the second wide opening to the narrow opening, the elastomer is compressed to generate a compressed elastic force;
wherein when the elastomer partly passes the narrow opening, the elastomer releases the compressed elastic force and moves towards the second wide opening or the first wide opening, so that the first casing slides with respect to the second casing;
wherein when the elastomer is at the first wide opening, the keypad is completely covered by the first casing;
wherein when the elastomer is at the second wide opening, the keypad is exposed outside the first casing.

17. The portable electronic device according to claim 16, wherein the first casing further comprises a second slide slot, the second slide slot is positioned at the other side of the guide slot, wherein the second casing further comprises a second slide track, a first side of the carrier is connected to the first slide track via the first slide slot, a second side of the carrier is connected to the second slide track via the second slide slot.

18. The portable electronic device according to claim 16, wherein a first circuit board is disposed inside the first casing, a second circuit board is disposed inside the second casing, the second surface has a hole, the portable electronic device further comprises:
a flexible circuit board for passing through the hole and the guide slot to electrically connect the first circuit board and the second circuit board.

19. The portable electronic device according to claim 16, wherein when the first casing slides with respect to the second casing, the first slide track slides within the first slide slot.
